(19) United States
(12) Patent Application Publication
(10) Pub. No.: US 2008/0218072 A1
(43) Pub. Date: Sep. 11, 2008

(54) Semiconductor light-emitting device and method for manufacturing semiconductor light-emitting device

(75) Inventors: Takao Haruna, Aichi-ken (JP); Akio Namiki, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 12/068,863

(22) Filed: Feb. 12, 2008

(30) Foreign Application Priority Data
Feb. 28, 2007 (JP) 2007-050305

(51) Int. Cl. H01J 1/62; H01J 9/02

(52) U.S. Cl. 313/506; 445/35

(57) ABSTRACT

A semiconductor light-emitting device in which a light-emitting diode including a light-emitting layer is placed directly on the bottom of a cup-shaped case or placed above the case bottom with a submount disposed therebetween includes a transparent primary sealing member that seals a side region, located under the light-emitting layer, surrounding the light-emitting diode that is fixed in the case; a transparent secondary sealing member disposed on the primary sealing member; and a uniform deposition layer formed by depositing phosphor particles or light diffuser particles contained in a material for forming the secondary sealing member. The phosphor particles or the light diffuser particles are deposited on the upper surface of the light-emitting diode and the upper surface of the primary sealing member to form a uniform layer that is as thin as a one-particle to five-particle layer.

### BACKGROUND OF THE INVENTION

1. Field of the Invention

The present invention relates to a semiconductor light-emitting device in which a light-emitting diode is placed directly on the bottom of a cup-shaped case or placed above the case bottom with a submount disposed therebetween and also relates to a method for manufacturing the semiconductor light-emitting device. The present invention particularly relates to the arrangement of particles of a phosphor or a light diffuser.

2. Description of the Related Art

The following documents disclose semiconductor light-emitting devices in which light-emitting diodes are placed on the bottoms of cup-shaped cases and which contain phosphors: Japanese Unexamined Patent Application Publication Nos. 2002-222996, 2004-111882, and 2006-93540. The semiconductor light-emitting devices are characterized in that the position (height) of each phosphor is limited to a certain level in such a manner that a sealant is packed in each case in two steps. This prevents the color shift of the light emitted from each semiconductor light-emitting device.

In the semiconductor light-emitting device, the phosphor is widely distributed in a layered region with a thickness greater than or equal to the height of a semiconductor chip. Therefore, the semiconductor light-emitting device has portions that are greatly different from each other in the collision frequency (collision probability) of photons with the phosphor depending on the direction in which light is emitted. This causes color shift. If the photons collide with the phosphor several times, the extraction efficiency of light is reduced. Hence, the collision frequency of a photon of output light with the phosphor is preferably zero or one in view of luminous efficiency. When the collision frequency is zero, the light emitted from the light-emitting diode is not absorbed with the phosphor but is emitted outside with the wavelength thereof being unchanged. When the collision frequency is one, the emitted light is absorbed with the phosphor once and is then emitted outside with the wavelength thereof being changed once.

In the semiconductor light-emitting device, the layered region, in which the phosphor is distributed, is thick in the vertical direction; hence, the emitted light is applied to the phosphor and is then absorbed with the phosphor several times. Therefore, it cannot be expected that the above ideal phenomenon occurs in the semiconductor light-emitting device.

### SUMMARY OF THE INVENTION

The present invention has been made to solve the above problem. It is an object of the present invention to provide a semiconductor light-emitting device in which no color shift occurs and which has high light extraction efficiency.

A device and method below are effective in solving the above problem.

A first aspect of the present invention provides a semiconductor light-emitting device in which a light-emitting diode including a light-emitting layer is placed directly on the bottom of a cup-shaped case or placed above the case bottom with a submount disposed therebetween. The semiconductor light-emitting device includes a transparent primary sealing member that seals a side region, including at least a side wall of the light-emitting layer and under the light-emitting layer, surrounding the light-emitting diode that is fixed in the case; a transparent secondary sealing member disposed on the primary sealing member; and a uniform deposition layer formed by depositing phosphor particles or light diffuser particles contained in a material for forming the secondary sealing member. The phosphor particles or the light diffuser particles are deposited on the upper surface of the light-emitting diode and the upper surface of the primary sealing member to form a uniform layer that is as thin as a one-particle to five-particle layer.

In the semiconductor light-emitting device, the primary sealing member may seal a side portion of the light-emitting layer or may entirely seal a side wall of the light-emitting diode. The primary sealing member seals a portion of the light-emitting diode the level of which is lower than or equal to the level of the top surface of the light-emitting layer. That is, the primary sealing member seals the side wall of the light-emitting diode, including at least a side wall of the light-emitting layer and under the light-emitting layer. The present invention does not exclude that the primary sealing member seals a side wall of a layer located above the level of the light-emitting layer. At least a portion of the upper surface of the light-emitting diode is uncovered from the primary sealing member. The entire upper surface of the light-emitting diode is preferably uncovered from the primary sealing member. The deposition layer is preferably located close to the light-emitting layer, which is a light source.

The deposition layer is preferably formed so as to be as thin as a one- or two-particle layer.

In the semiconductor light-emitting device, the phosphor particles or the light diffuser particles preferably have a diameter of 1 to 30 μm.

A second aspect of the present invention provides a method for manufacturing a semiconductor light-emitting device in which a light-emitting diode including a light-emitting layer is placed directly on the bottom of a cup-shaped case or placed above the case bottom with a submount disposed therebetween. The method includes a first providing step of providing a first curable material for forming a transparent primary sealing member in a side region, including at least a side wall of the light-emitting layer and under the light-emitting layer, surrounding the light-emitting diode that is fixed in the case; a first curing step of curing the first curable material to form the primary sealing member; a second providing step of providing a second curable material, containing phosphor particles or light diffuser particles, for forming a transparent secondary sealing member on the upper surface of the light-emitting diode and the upper surface of the primary sealing member; a precipitation step of depositing the phosphor particles or the light diffuser particles on the upper surface of the light-emitting diode and the upper surface of the primary sealing member with centrifugal force to form a uniform layer that is as thin as a one-particle to five-particle layer; and a second curing step of curing the second curable material to form the secondary sealing member.

In the method, the primary sealing member may seal a side portion of the light-emitting layer or may entirely seal a side wall of the light-emitting diode. The primary sealing member seals a portion of the light-emitting diode the level of which is lower than or equal to the level of the light-emitting layer. The present invention does not exclude that the primary sealing member seals a side wall of a layer located above the level of the light-emitting layer. At least a portion of the upper surface of the light-emitting diode is uncovered from the primary sealing member. The entire upper surface of the light-emitting diode is preferably uncovered from the primary sealing member.

The phosphor particles or the light diffuser particles are preferably deposited uniformly so as to form a one- or two-particle layer.

In the precipitation step, the phosphor particles or the light diffuser particles are preferably precipitated with, for example, a centrifuge.

In the method, the precipitation step preferably uses a swing-type centrifuge having a mechanism for causing the direction of the resultant of gravity and centrifugal force to always agree with the direction normal to the upper surface of the light-emitting diode.

In the method, the phosphor particles or the light diffuser particles preferably have a diameter of 1 to 30 μm.

The above problem can be effectively solved with the semiconductor light-emitting device or the method.

Advantages of the present invention are as described below.

According to the first aspect of the present invention, the deposition layer is formed densely and uniformly so as to be as thin as a one-particle to five-particle layer and the light emitted from the light-emitting layer passes through the deposition layer once independently of the direction of the emitted light. Therefore, the collision frequency of each photon of the emitted light with one of the phosphor or light diffuser particles, which are contained in the deposition layer, is limited to zero or one, that is, the number of times the emitted light is scattered or the wavelength of the emitted light is changed is limited to zero or one. The deposition layer is located very close to the light-emitting layer, that is, the deposition layer is located in a region having high luminous flux density. Therefore, although the deposition layer has a very small thickness as described above, the collision frequency of the photon with one of the phosphor or light diffuser particles can be secured to be high.

According to the above configuration, the emitted light can be scattered or the wavelength of the emitted light can be changed sufficiently. When the deposition layer contains the phosphor particles, the color shift of the light extracted from the semiconductor light-emitting device can be prevented and the light extraction efficiency of the semiconductor light-emitting device is enhanced. When the deposition layer contains the light diffuser particles, the light extraction efficiency thereof is also enhanced because the light diffuser particles do not excessively scatter the emitted light.

That is, according to the first aspect of the present invention, the color shift of the light extracted from the semiconductor light-emitting device can be prevented and the light extraction efficiency of the semiconductor light-emitting device can be enhanced.

The precipitation step of precipitating the phosphor or light diffuser particles with centrifugal force is effective in uniformly forming the deposition layer such that the deposition layer is located at such a desired position as described above and is dense and thin. In the method, the deposition layer can be readily and securely formed on the upper surface of the light-emitting diode and the upper surface of the primary sealing member.

Since the swing-type centrifuge is used, the second curable material can be subjected to the second curing step in such a state that the phosphor or light diffuser particles are precipitated with centrifugal force. Therefore, the deposition layer can be formed as designed.

The phosphor or light diffuser particles preferably have a diameter of 1 to 30 μm depending on the desired wavelength of modulated or unmodulated light or the desired reflectance of the phosphor or light diffuser particles. When the phosphor or light diffuser particles preferably have an excessively large or small diameter, it is difficult to uniformly form the deposition layer and therefore it is difficult to solve problems involved in color shift and light extraction efficiency.

### BRIEF DESCRIPTION OF THE DRAWINGS

FIG. 1 is a sectional view of a semiconductor light-emitting device according to a first embodiment of the present invention.

FIG. 2 is a conceptual view showing the operation of a swing-type centrifuge.

FIG. 3A is a sectional view of a first comparative semiconductor light-emitting device and FIG. 3B is a sectional view of a second comparative semiconductor light-emitting device.

FIG. 4 is a graph showing the relationship between the intensity and chromaticity of the light emitted from each of the semiconductor light-emitting device, the first comparative semiconductor light-emitting device, and the second comparative semiconductor light-emitting device.

FIG. 5 is a graph showing the relationship between the intensity and chromaticity of the light emitted from each of the semiconductor light-emitting device, a first sample, and a second sample.

### DESCRIPTION OF THE PREFERRED EMBODIMENTS

Embodiments of the present invention will now be described in detail.

The present invention is not limited to the embodiments.

### First Embodiment

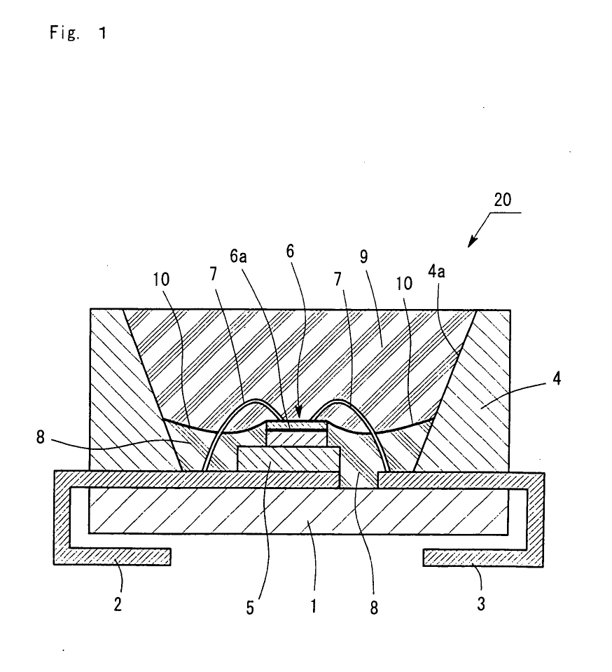

FIG. 1 is a sectional view of a semiconductor light-emitting device 20 according to a first embodiment of the present invention. The semiconductor light-emitting device 20 includes a light-emitting diode 6, prepared by growing a crystal of a Group-III nitride compound semiconductor on a sapphire substrate, emitting blue light with a peak emission wavelength of 460 nm. The light-emitting diode 6 is soldered on a submount 5 in a face-up manner. The submount 5 is made of aluminum (Al) and is fixed to a first lead electrode 2. The light-emitting diode 6 has electrodes connected to the first lead electrode 2 and a second lead electrode 3 with bonding wires 7. The first and second lead electrode 2 and 3 are made of metal and are fixed on an insulating resin substrate 1. A resin case 4 coated with a reflecting agent 4a is fixed on the first and second lead electrode 2 and 3. The inner wall of the resin case 4 is inclined, because the extraction efficiency of output light is enhanced by the reflection effect of the reflecting agent 4a. The resin substrate 1 and the resin case 4 may be integrally formed.

The light-emitting diode 6 is fixed in the resin case 4 and includes a light-emitting layer 6a having a side surface sealed with a primary sealing member 8 made of a transparent first epoxy resin. The upper surface of the primary sealing member 8 is recessed because of the surface tension of the first epoxy resin that is not cured yet and therefore is liquid in a step of providing the first epoxy resin. The upper surface of the primary sealing member 8 is substantially flash with the upper surface of the light-emitting diode 6. The primary sealing member 8 is overlaid with a secondary sealing member 9 made of a transparent second epoxy resin. A deposition layer 10 is disposed between the primary and secondary sealing members 8 and 9 and is a deposition that is formed in such a manner that particles of a phosphor contained in the second epoxy resin, which is used to form the secondary sealing member 9, are precipitated so as to be densely and thinly deposited on the primary sealing member 8. The deposition layer 10 has a thick portion located on a center area of the upper surface of the light-emitting diode 6 and also has another thick portion located on the bottom of the recessed upper surface of the primary sealing member 8, these thick portions having a thickness of about 10 μm. The phosphor particles have a diameter of about 2 to 8 μm. The phosphor is made of cerium-doped yttrium aluminum garnet (Ce:YAG) and absorbs the blue light emitted from the light-emitting diode 6 to emit yellow light.

A method for manufacturing the semiconductor light-emitting device 20 will now be described with particular emphasis on the formation of the deposition layer 10.

The submount 5 is fixed on the first lead electrode 2. The rear surface of the light-emitting diode 6 is soldered onto the upper surface of the submount 5. The electrodes of the light-emitting diode 6 are electrically connected to the first and second lead electrode 2 and 3 with the bonding wires 7. This allows the light-emitting diode 6 to be fixed in the resin case 4.

### First Providing Step

The transparent, liquid first epoxy resin, which is used to form the primary sealing member 8, is provided in a side region surrounding the light-emitting diode 6. In this step, it is preferable that the upper surface of the light-emitting diode 6 be not completely covered with the first epoxy resin. It is more preferable that the upper surface of the light-emitting diode 6 be uncovered with the first epoxy resin. A side surface of a semiconductor chip whose level is lower than or equal to the level of the top surface of the light-emitting layer 6a is covered with the first epoxy resin so that the side wall of the light-emitting layer 6a may be entirely covered with the first epoxy resin.

### First Curing Step

The first epoxy resin is cured by heat treatment. This allows the primary sealing member 8 to be formed as shown in FIG. 1. The upper surface of the primary sealing member 8 is recessed because of the surface tension of the first epoxy resin that is liquid in the first providing step.

### Second Providing Step

The transparent, liquid second epoxy resin, which contains the phosphor particles and is used to form the secondary sealing member 9, is provided on the upper surface of the light-emitting diode 6 and the upper surface of the cured primary sealing member 8. The amount of the phosphor particles in the second epoxy resin is preferably adjusted such that the deposition layer 10 has a thickness of 10 μm or less as shown in FIG. 1.

### Precipitation Step

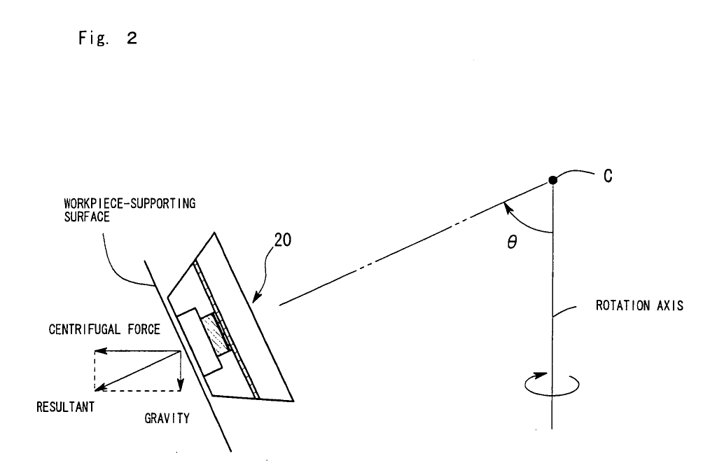

The phosphor particles are deposited on the upper surface of the light-emitting diode 6 and the upper surface of the primary sealing member 8 with centrifugal force so as to form a uniform layer that is as thin as a one- or two-particle layer. For example, the following centrifuge is used in this step: a swing-type centrifuge configured such that the resultant of gravity and centrifugal force is directed in the direction normal to the upper surface of the light-emitting diode 6 as shown in FIG. 2. The deposition layer 10 can be uniformly formed so as to have a thickness of 10 μm or less and high density in such a manner that centrifugal force is applied to the phosphor particles by rotating the swing-type centrifuge at about 1,500 rpm for one minute. FIG. 2 shows the conceptual operation of the swing-type centrifuge. The swing-type centrifuge has such a workpiece-supporting surface that the direction of the normal to the workpiece-supporting surface always agrees with the direction of the resultant of gravity and centrifugal force. While the swing-type centrifuge is being rotated at high speed, the rotation axis of the swing-type centrifuge forms substantially a right angle with the resultant thereof. The angle formed by the rotation axis thereof and the resultant is represented by θ in FIG. 2. The direction of the resultant swings around a swing center C located on the rotation axis. The angle θ reduces with a reduction in the rotation speed of the swing-type centrifuge. The swing center C need not be necessarily located on the rotation axis and may be spaced from the rotation axis.

### Second Curing Step

The second epoxy resin, which is used to from the secondary sealing member 9, is cured by heat treatment in such a state that the phosphor particles are deposited. In order to maintain the deposition of the phosphor particles, the swing-type centrifuge is preferably used.

The semiconductor light-emitting device 20, which is shown in FIG. 1 in cross section, can be manufactured through the above steps.

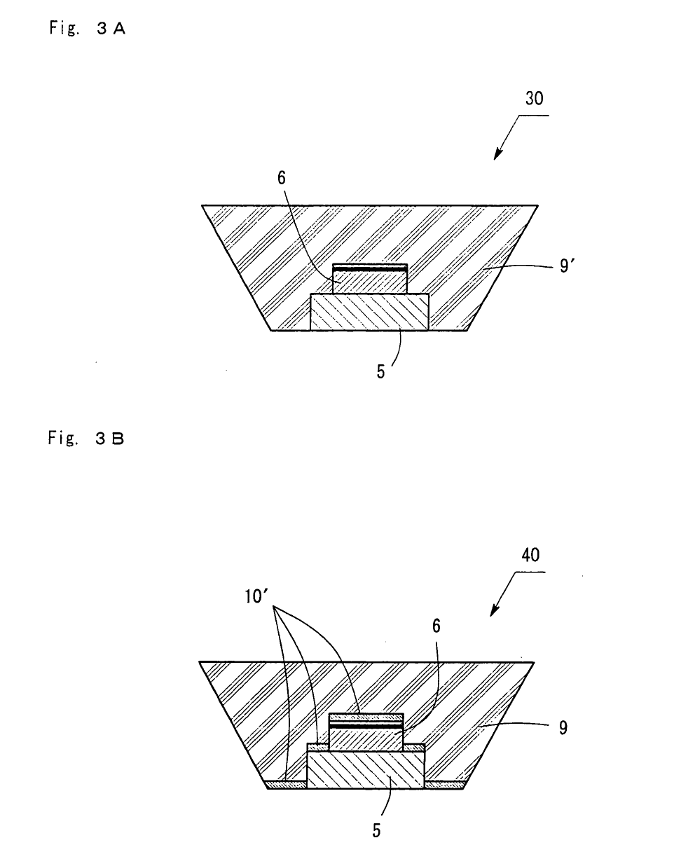

FIG. 3A is a schematic sectional view of a first comparative semiconductor light-emitting device 30 and FIG. 3B is a schematic sectional view of a second comparative semiconductor light-emitting device 40. In these devices, an epoxy resin for forming a sealing member is provided in one step. As shown in FIG. 3A, the first comparative semiconductor light-emitting device 30 as well as the semiconductor light-emitting device 20 includes a light-emitting diode 6, bonding wires for supplying electricity to this light-emitting diode 6, and a resin case 4. The first comparative semiconductor light-emitting device 30 can be manufactured as follows: this light-emitting diode 6 is fixed in this resin case 4 by the same procedure as that for manufacturing the semiconductor light-emitting device 20 and an epoxy resin for forming a sealing member 9′ is mixed with an adequate amount of the phosphor particles and is then cured without precipitating the phosphor particles in a subsequent sealing step such that the sealing member 9′ is formed.

As shown in FIG. 3B, the second comparative semiconductor light-emitting device 40 includes a light-emitting diode 6 and deposition layers 10′ formed from the phosphor particles. Before an epoxy resin for sealing this light-emitting diode 6 is cured, the phosphor particles are precipitated. This epoxy resin is cured by the same procedure as that for manufacturing the first comparative semiconductor light-emitting device 30. The step of precipitating the phosphor particles is the same as the precipitating step included in the method for manufacturing the semiconductor light-emitting device 20. The deposition layers 10′ of the second comparative semiconductor light-emitting device 40, as well as the deposition layer 10 of the semiconductor light-emitting device 20, have a thickness of about 10 μm.

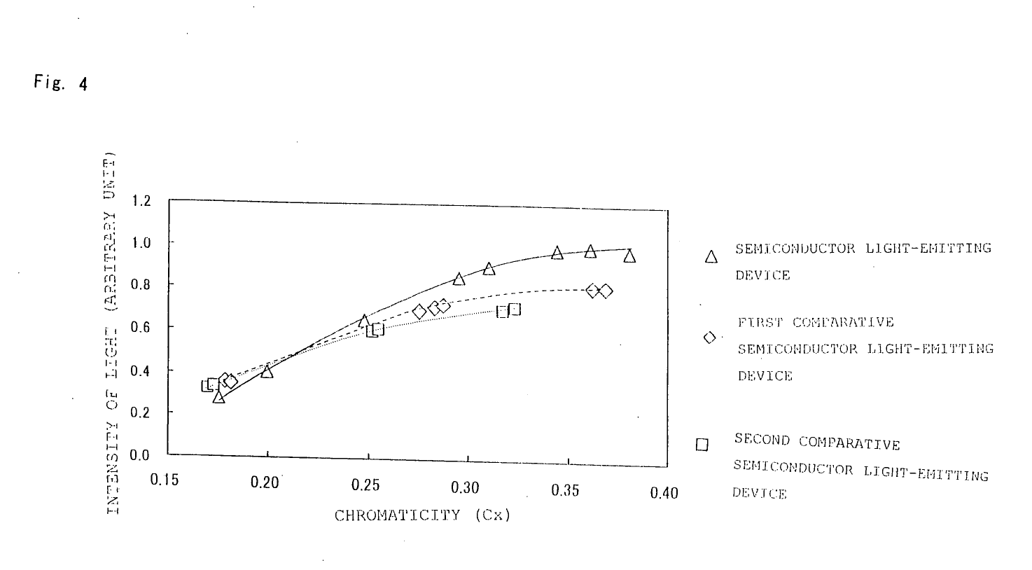

FIG. 4 is a graph showing the relationship between the intensity and chromaticity (Cx) of the light emitted from each of the semiconductor light-emitting device 20, the first comparative semiconductor light-emitting device 30, and the second comparative semiconductor light-emitting device 40. With reference to FIG. 4, symbols A represent measurement spots on the semiconductor light-emitting device 20, symbols ⋄ represent measurement spots on the first comparative semiconductor light-emitting device 30, and symbols □ represent measurement spots on the second comparative semiconductor light-emitting device 40. The graph illustrates that the intensity of the light emitted from the semiconductor light-emitting device 20 is about five percent higher than that of the light emitted from the first comparative semiconductor light-emitting device 30.

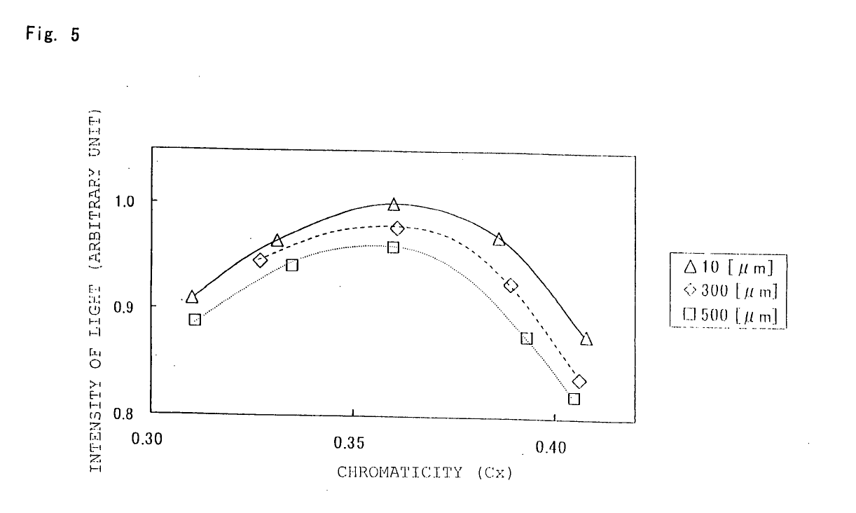

FIG. 5 is a graph showing the relationship between the intensity and chromaticity of the light emitted from each of the semiconductor light-emitting device 20, a first sample, and a second sample. The first and second samples have substantially the same configuration as that of the semiconductor light-emitting device 20 except that the first sample includes a 300-μm thick deposition layer and the second sample includes a 500-μm thick deposition layer. With reference to FIG. 5, symbols Δ represent measurement spots on the semiconductor light-emitting device 20, symbols ⋄ represent measurement spots on the first sample, and symbols a represent measurement spots on the second sample.

The graph shown in FIG. 5 illustrates that the deposition layer 10 preferably has a small thickness. Since the phosphor particles have a diameter of about 2 to 8 μm, the deposition layer 10 is preferably formed so as to have a thickness equal to that of a one- or two-particle layer. This result agrees with the concept of the present invention that the collision frequency of a photon of light with one of the phosphor particles is preferably zero or one. In the semiconductor light-emitting device 20, which includes the deposition layer 10 with a thickness of about 10 μm, each photon of the light emitted from the light-emitting diode 6 passes through the deposition layer 10 once. The photon collides with none or one of the phosphor particles once when the photon passes through the deposition layer 10. The collision probability of the photon is probably constant independently of regions of the deposition layer 10.

Since the thickness of the deposition layer 10 is about 10 μm, no color shift occurs in the semiconductor light-emitting device 20. The light emitted from the semiconductor light-emitting device 20 has high intensity as shown in FIGS. 4 and 5.

### Modifications

The present invention is not limited to the first embodiment and modifications below may be made. Such modifications or variations are effective in achieving advantages of the present invention.

### First Modification

In the first embodiment, the deposition layer 10 has a thickness equal to that of a one- or two-particle layer. The deposition layer 10 may have a thickness equal to that of a one-particle to five-particle layer depending on target chromaticity. The collision frequency of a photon with one of the phosphor particles or light diffuser particles is preferably zero or one in view of light shift and/or luminous efficiency and therefore the deposition layer 10 preferably has a thickness equal to that of such a one- or two-particle layer. In order to increase the collision frequency thereof, the deposition layer 10 may have a thickness equal to that of such a one-particle to five-particle layer depending on target chromaticity. Even under such a design condition, color shift can be effectively prevented in such a manner that the deposition layer 10 is uniformly formed.

### Second Modification

In the semiconductor light-emitting device 20 according to the first embodiment, the liquid second epoxy resin which is not cured yet and which is used to form the secondary sealing member 9, may contain particles of a light diffuser instead of or in addition to the phosphor particles. In this case, the deposition layer 10 contains the light diffuser particles and/or the phosphor particles and can be formed densely and uniformly so as to have an extremely small thickness; hence, the deposition layer 10 is effective in achieving a sufficient light-diffusing effect. This configuration is effective in preventing a reduction in luminous efficiency due to unnecessary scattering.

### Third Modification

In the semiconductor light-emitting device 20 according to the first embodiment, the light-emitting diode 6 is fixed in a face-up manner. The light-emitting diode 6 may be fixed in a face-down manner. Any technique may be used to supply the electrodes of the light-emitting diode 6 with current and the bonding wires 7 need not be necessarily used. In the semiconductor light-emitting device 20, the first and second epoxy resins are used to form the primary and secondary sealing members 8 and 9, respectively. Any transparent resin that can be subjected to potting, precipitation, and/or curing may be used to form the primary or secondary sealing member 8 or 9. The light-emitting diode 6 may be sealed with a silicone instead of the first or second epoxy resin.

The position of the interface between the primary and secondary sealing members 8 and 9 and the configuration of the deposition layer 10, which is located between the primary and secondary sealing members 8 and 9 are as described in the first embodiment. The shape of the primary and secondary sealing members 8 and 9 is not particularly limited. Other sealing members may be used instead of the primary and secondary sealing members 8 and 9. A technique for sealing the deposition layer 10 with the sealing members is not particularly limited.

A semiconductor light-emitting device according to the present invention can be used for various lighting units, indicators for displaying information, dot matrix displays, and illuminations.

What is claimed is:

1. A semiconductor light-emitting device in which a light-emitting diode including a light-emitting layer is placed directly on the bottom of a cup-shaped case or placed above the case bottom with a submount disposed therebetween, comprising:
a transparent primary sealing member that seals a side region, including at least a side wall of the light-emitting layer and under the light-emitting layer, surrounding the light-emitting diode that is fixed in the case;
a transparent secondary sealing member disposed on the primary sealing member; and
a uniform deposition layer formed by depositing phosphor particles or light diffuser particles contained in a material for forming the secondary sealing member,
wherein the phosphor particles or the light diffuser particles are deposited on the upper surface of the light-emitting diode and the upper surface of the primary sealing member to form a uniform layer that is as thin as a one-particle to five-particle layer.

2. The semiconductor light-emitting device according to claim 1, wherein the phosphor particles or the light diffuser particles have a diameter of 1 to 30 μm.

3. A method for manufacturing a semiconductor light-emitting device in which a light-emitting diode including a light-emitting layer is placed directly on the bottom of a cup-shaped case or placed above the case bottom with a submount disposed therebetween, the method comprising:
a first providing step of providing a first curable material for forming a transparent primary sealing member in a side region, including at least a side wall of the light-emitting layer and under the light-emitting layer, surrounding the light-emitting diode that is fixed in the case;
a first curing step of curing the first curable material to form the primary sealing member;
a second providing step of providing a second curable material, containing phosphor particles or light diffuser particles, for forming a transparent secondary sealing member on the upper surface of the light-emitting diode and the upper surface of the primary sealing member;
a precipitation step of depositing the phosphor particles or the light diffuser particles on the upper surface of the light-emitting diode and the upper surface of the primary sealing member with centrifugal force to form a uniform layer that is as thin as a one-particle to five-particle layer; and
a second curing step of curing the second curable material to form the secondary sealing member.

4. The method according to claim 3, wherein the precipitation step uses a swing-type centrifuge having a mechanism for causing the direction of the resultant of gravity and centrifugal force to always agree with the direction normal to the upper surface of the light-emitting diode.

5. The method according to claim 3, wherein the phosphor particles or the light diffuser particles have a diameter of 1 to 30 μm.

6. The method according to claim 4, wherein the phosphor particles or the light diffuser particles have a diameter of 1 to 30 μm.
